(19) United States
(12) Patent Application Publication
(10) Pub. No.: US 2004/0222584 A1
(43) Pub. Date: Nov. 11, 2004

(54) Process and apparatus for producing multi-leaf printed products

(75) Inventors: Eberhard Krieger, Weinstadt-Struempfelbach (DE); Klaus Stocklossa, Marbach (DE); Georg Dannemann, Backnang (DE)

Correspondence Address: ROTHWELL, FIGG, ERNST & MANBECK, P.C., 1425 K STREET, N.W., SUITE 800, WASHINGTON, DC, 20005, US

(73) Assignee: Maschinenbau Oppenweiler Binder GmbH & Co. KG, Oppenweiler (DE)

(21) Appl. No.: 10/834,272

(22) Filed: Apr. 29, 2004

(30) Foreign Application Priority Data
May 8, 2003 (EP) 03 010 429.3
Sep. 23, 2003 (DE) 103 44 026.7

(51) Int. Cl. B41L 43/00

(52) U.S. Cl. 270/32

(57) ABSTRACT

In the case of the process for producing multi-leaf printed products, different types of sheets, which are printed by various printing methods, are set down one after the other in the conveying direction, in accordance with a freely selectable sequence, on a main conveying device at different set-down stations, the sheets subsequently being folded one after the other and then collated one above the other.

### FIELD OF THE INVENTION

The invention relates to a process for producing multi-leaf printed products, in the case of which sheets are set down one after the other in the conveying direction on a main conveying device at different set-down stations and are subsequently folded and collected.

### DESCRIPTION OF THE BACKGROUND ART

DE 102 20 550 A1 discloses an apparatus which is intended for producing multi-leaf printed products and comprises a plurality of magazines which are charged with printed, non-folded sheet stacks and each have a sheet feeder. The magazines are arranged in a row, such that they are aligned in the sheet-running direction, and are coupled to a buckle folder by means of an automatic conveying device which spans the magazines. The printed sheets, when set down in the magazines, are already in the sequence which is necessary for producing the final printed product. The sheets, produced by offset printing, are always set down in the same sequence on the conveying device, folded by the buckle folder and collated one above the other.

Since, in the case of the known apparatus, the same type of sheet is arranged in each magazine in each case and the sequence in which the sheets are set down on the conveying device is firmly predetermined, it is possible to produce in each case just one variant of the printed product.

### SUMMARY OF THE INVENTION

The object of the invention is to provide a process and an apparatus which are intended for producing multi-leaf printed products and by means of which it is possible to produce optionally multi-leaf printed products with different contents, in particular personalized printed products.

This object is achieved according to the invention by a process for producing multi-leaf printed products, wherein different types of sheets, which are printed by various printing methods, are set down successively in a conveying direction of a main conveying device, in accordance with a freely selectable sequence, on said main conveying device at different set-down stations, the sheets subsequently being folded successively and then collated one above the other.

In the case of the process according to the invention, the sheets are set down one after the other, in a freely selectable sequence, on the main conveying device. The sequence can be stored in a control device, which controls the individual set-down stations and the main conveying device such that the sheets are set down in the desired sequence on the conveying device and subsequently folded and collected.

The process according to the invention is advantageous, in particular, when one type of sheet has been produced by offset printing and at least one type of sheet has been produced by digital printing. The sheets produced by offset printing may then form a general part of the printed product, while personalized pages can be introduced by way of the sheets produced by digital printing.

The number of pages of the multi-leaf printed products can be configured particularly freely if both folded and non-folded sheets can be set down on the conveying device, the intention being for the folded sheets, once folded, to be of the same size as the non-folded sheets.

It is preferable for one type of sheet to be set down in the main conveying direction at the upstream end of the main conveying device—as seen in the conveying direction—and for at least one other type of sheet to be set down on the main conveying device transversely to the conveying direction. For example, it is possible for personalized sheets produced by digital printing to be set down on the main conveying device at a distance apart from one another in the conveying direction. The sheets produced by offset printing can then be set down in a freely selectable sequence between the sheets produced by digital printing.

An apparatus for carrying out the process according to the invention comprises a main conveying device for transporting sheets set down thereon, a main set-down station, which is provided at an upstream end of said main conveying device—as seen in said conveying direction of said main conveying device—and is intended for setting down sheets in said conveying direction on said main conveying device, at least one secondary set-down station, which is provided on a longitudinal side of said main conveying device and is intended for setting down sheets on said main conveying device in a direction transverse to said conveying direction of said main conveying device, a former folder, which is provided at a downstream end of said main conveying device—as seen in said conveying direction of said main conveying device—and has a collecting device provided downstream of its outlet, said sheets which are folded by said former folder being collated one above the other in said collecting device, said main and secondary set-down stations comprising a sheet feeder, and a buckle folder being provided downstream of said sheet feeder at least of said main set-down station or of a secondary set-down station.

### BRIEF DESCRIPTION OF THE DRAWINGS

Exemplary embodiments of the invention are explained in more detail hereinbelow with reference to drawings, in which:

FIG. 1 shows a schematic plan view of a first embodiment of an apparatus for producing multi-leaf printed products;

FIG. 2 shows, schematically, the operations of feeding sheets and processing them further in the case of the apparatus of FIG. 1;

FIG. 3 shows a schematic plan view of a second embodiment of an apparatus for producing multi-leaf printed products;

FIG. 4 shows, schematically, the operations of feeding sheets and processing them further in the case of the apparatus of FIG. 3;

FIG. 5 shows a schematic plan view of a third embodiment of an apparatus for producing multi-leaf printed products;

FIG. 6 shows, schematically, the operations of feeding sheets and processing them further in the case of the apparatus of FIG. 5;

FIG. 7 shows a schematic plan view of a fourth embodiment of an apparatus for producing multi-leaf printed products; and

FIG. 8 shows, schematically, the operations of feeding sheets and processing them further in the case of the apparatus of FIG. 7.

### DETAILED DESCRIPTION OF THE INVENTION

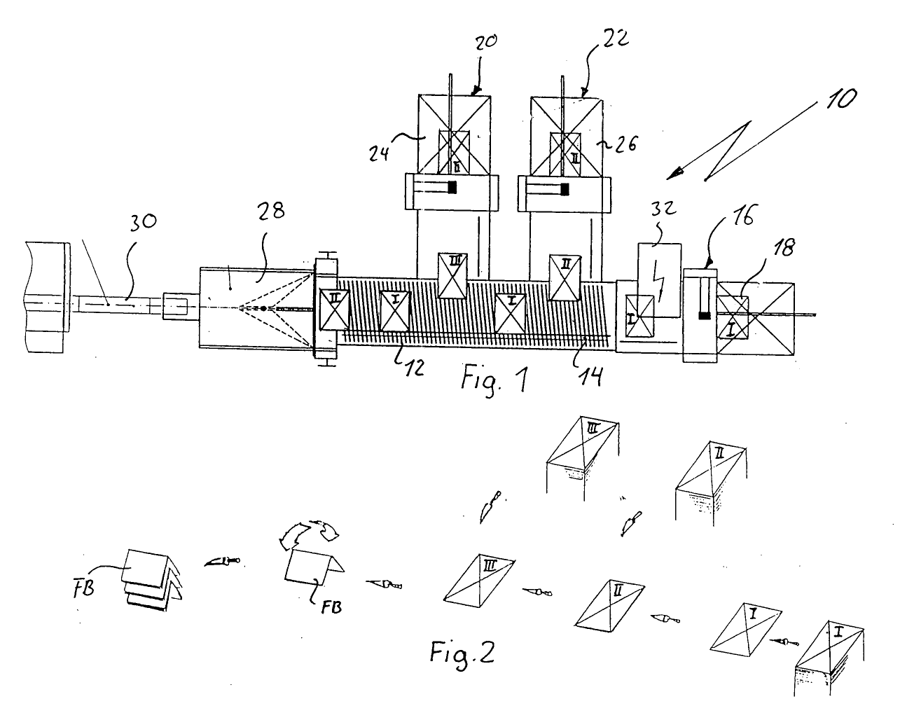

The apparatus 10, shown in FIG. 1, for producing multi-leaf printed products has, as conveying device, an angled-roller table 12 with an aligning guide 14 extending in the conveying direction of the angled-roller table 12. Arranged at the left-hand end in FIG. 1, i.e. the upstream end of the angled-roller table 12, as seen in the conveying direction, is a main set-down station 16, which sets down a first sheet I on the angled-roller table 12 in the conveying direction. The main set-down station 16 comprises a sheet feeder 18, on which is set down a stack of first sheets I, which have been produced, in accordance with a corresponding sequence, by digital printing. Individual sheets I are printed with different personalized details.

Spaced apart from one another in the conveying direction along the top longitudinal side of the angled-roller table 12 in FIG. 1 are two secondary set-down stations 20, 22, which set down respective sheets III and II on the angled-roller table 12 transversely to the conveying direction of the latter. The two secondary set-down stations 20, 22 likewise comprise a sheet feeder 24, 26, which feeds the respective sheets III and II to the angled-roller table 12. All the sheets III in the sheet feeder 24 and all the sheets II in the sheet feeder 26 are printed in the same way in each case by offset printing.

Arranged at the left-hand, i.e. downstream, end of the angled-roller table 12 in FIG. 1 is a former folder 28, which is configured such that the sheets I, II, III conveyed by the angled-roller table 12 are folded by it one after the other such that the folded sheet FB is open in the downward direction, as is shown schematically in FIG. 2. The former folder 28 is followed by a collecting device 30, in which the sheets folded by the former folder 28 are set down one above the other. The collecting device 30 may be followed by a binding device (not shown), which binds together the collated folded sheets FB.

The main set-down station 18 and the two secondary set-down stations 20, 22, the angled-roller table 12, the former folder 28 and the collecting device 30 are controlled centrally by a control device 32. The sequence in which the individual sheets are set down on the angled-roller table 12 can be selected freely and entered into the control device 32. The control device 32 then controls the individual subassemblies such that the sheets I, II and III are fed to the former folder 28, in accordance with the entered sequence, and collated one above the other in the collecting device 30.

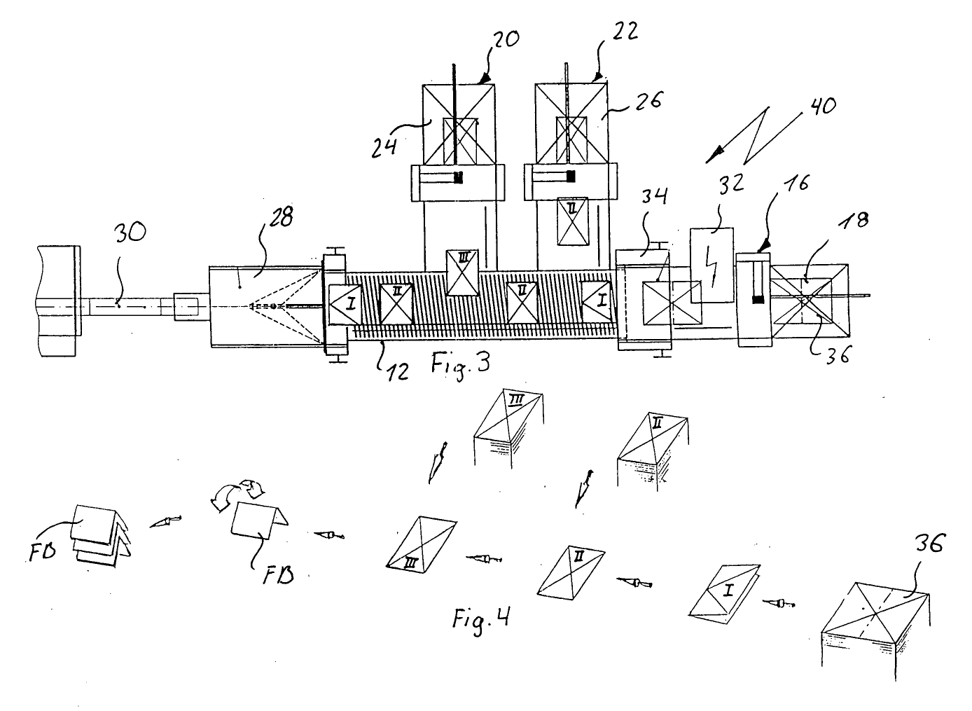

The apparatus 40, shown in FIG. 3, for producing multi-leaf printed products differs from the apparatus 10, shown in FIG. 1, in that the main set-down station 16, following the sheet feeder 18, has a buckle folder 34. The sheets 36 stacked in the sheet feeder 18 are of double length, as seen in the conveying direction, and are folded by the buckle folder 34 such that the sheets I set down on the angled-roller table 12 are of the same size as the sheets II and III which are fed by the sheet feeders 24, 26. The folding edge of the folded sheet I is directed toward the former folder 28.

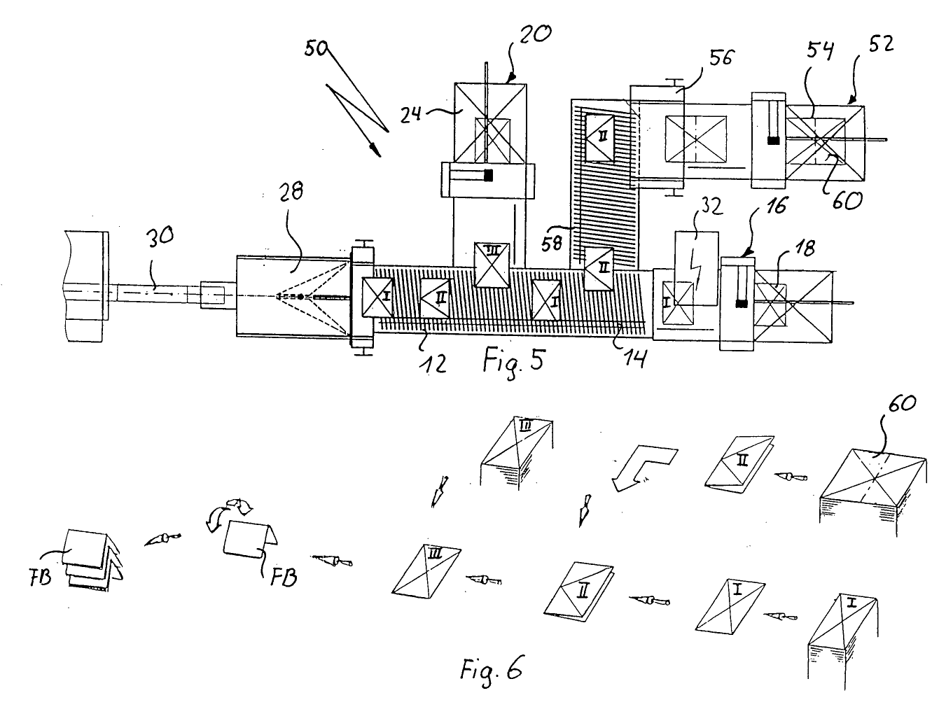

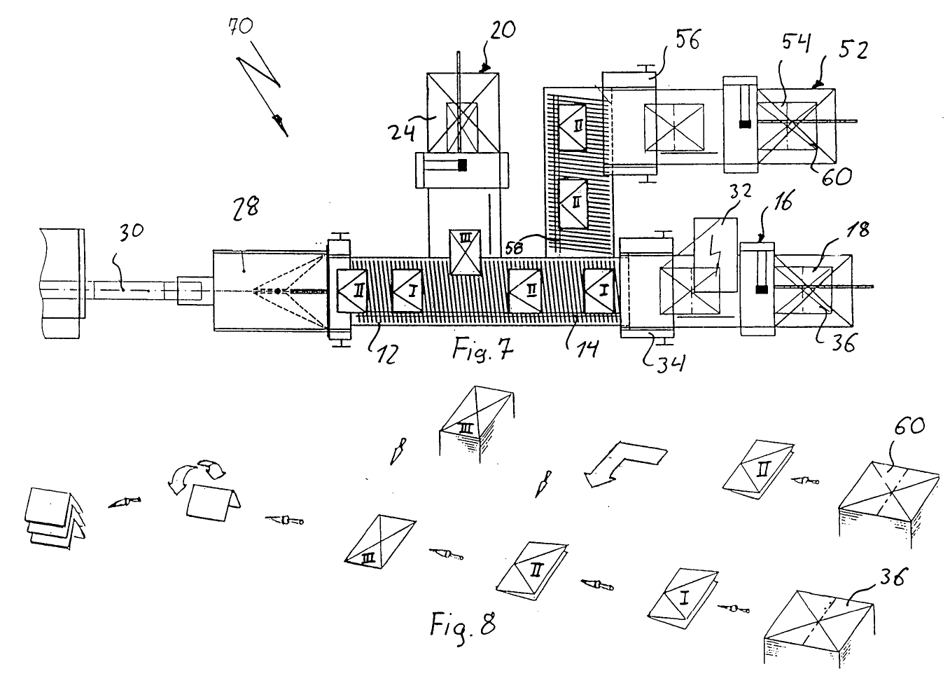

The apparatus 50, shown in FIG. 5, for producing multi-leaf printed products differs from the apparatus which is shown in FIG. 1 in that, instead of the secondary set-down station 22, a secondary set-down station 52 is provided, the latter being arranged parallel to, and at a distance from, the main set-down station 16. The secondary set-down station 52 comprises a sheet feeder 54 with a buckle folder 56 provided downstream of it, a sheet which is fed by the sheet feeder 60 being folded by said buckle folder to form the sheet II. The sheet II runs out of the buckle folder 56 parallel to the conveying direction of the angled-roller table 12 and is set down on an angled-roller table 58, which is arranged transversely to the angled-roller table 12 and sets down the sheets II on the angled-roller table 12 transversely to the conveying direction of the angled-roller table 12.

The apparatus 70, shown in FIG. 7, for producing multi-leaf printed products differs from the apparatus which is shown in FIG. 5 in that, like the equipment of FIG. 3, the main set-down station 16, following the sheet feeder 18, has a buckle folder 34. This means that both the sheets I and the sheets II are folded once and introduced into the former folder 28 with the folding edge in front.

The abovedescribed apparatuses 10, 40, 50 and 70 make it possible to bind together digitally printed sheets, and sheets which are produced by offset printing, in different sequences. This makes it possible to produce multi-leaf printed products which comprise a general part and a personalized, customer-specific part. The general part, for cost-related reasons, is printed by offset printing, while the customer-specific part is printed by digital printing.

The abovedescribed embodiments each have a main set-down and two secondary set-down stations. Depending on requirements, however, it is also possible to use more than two secondary set-down stations.

What is claimed:

1. A process for producing multi-leaf printed products, wherein different types of sheets, which are printed by various printing methods, are set down successively in a conveying direction of a main conveying device, in accordance with a freely selectable sequence, on said main conveying device at different set-down stations, the sheets subsequently being folded successively and then collated one above the other.

2. The process as claimed in claim 1, wherein at least one type of said sheets has been produced by offset printing and at least one type of said sheets has been produced by digital printing.

3. The process as claimed in claim 1, wherein already folded and/or non-folded sheets are set down on said main conveying device.

4. The process as claimed in claim 1, wherein one type of sheet is set down in the conveying direction at said upstream end of said main conveying device, as seen in said conveying direction, and at least one other type of sheet is set down on said main conveying device transversely to said conveying direction.

5. An apparatus for producing multi-leaf printed products from different types of sheet, which are printed by various printing methods, having
a main conveying device for transporting sheets set down thereon,
a main set-down station, which is provided at an upstream end of said main conveying device—as seen in said conveying direction of said main conveying device—and is intended for setting down sheets in said conveying direction on said main conveying device,
at least one secondary set-down station, which is provided on a longitudinal side of said main conveying device and is intended for setting down sheets on said main conveying device in a direction transverse to said conveying direction of said main conveying device,
a former folder, which is provided at a downstream end of said main conveying device—as seen in said conveying direction of said main conveying device—and has a collecting device provided downstream of its outlet, said sheets which are folded by said former folder being collated one above the other in said collecting device,
said main and secondary set-down stations comprising a sheet feeder, and a buckle folder being provided downstream of said sheet feeder at least of said main set-down station or of a secondary set-down station.

6. The apparatus as claimed in 5, wherein provided downstream of said buckle folder of at least one secondary set-down station is a secondary conveying device, of which said conveying direction is directed transversely to said conveying direction of said main conveying device, said buckle folder being arranged such that a sheet passing out of said buckle folder is deposited on said secondary conveying device transversely to said conveying direction of the latter and, by way of said secondary conveying device, is deposited on said main conveying device transversely to said conveying direction of the latter.

7. The apparatus as claimed in claim 5, wherein said main conveying device comprises an angled-roller table.

8. The apparatus as claimed in claim 7, wherein said secondary conveying device comprises an angled-roller table.
